(19) United States
(12) Patent Application Publication
(10) Pub. No.: US 2004/0260407 A1
(43) Pub. Date: Dec. 23, 2004

(54) Home automation control architecture

(76) Inventor: William Wimsatt, Littleton, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/820,434

(22) Filed: Apr. 8, 2004

Related U.S. Application Data
(60) Provisional application No. 60/461,307, filed on Apr. 8, 2003.

(51) Int. Cl. G05B 11/01; G05B 15/00; G05B 19/18

(52) U.S. Cl. 700/19; 700/20; 700/65; 700/66

(57) ABSTRACT

A home automation and control architecture that includes one or more controlled devices and one or more control panels coupled by a communication network. Each of the controlled devices is directly coupled to at least one control panel and configured to communicate control information with the coupled panel. The control panels comprise sufficient computing resources for implementing a user interface and executing application software to generate control messages based on user input and/or context information of which the control panel is aware. A message broker implemented within the pone or more control panels conveys control messages from a first control panel that initiates the control message to one or more other control panels that implement the control message. An inter-control communication path couples each of the control panels such that any one of the control panels can effect control over any of the controlled devices by communicating through another control panel that is directly coupled to a specific device.

### RELATED APPLICATIONS

The present invention claims the benefit of U.S. Provisional Patent Application Ser. No. 60/461,307 filed on Apr. 8, 2003 entitled Home Automation Control Architecture.

### BACKGROUND OF THE INVENTION

1. Field of the Invention

The present invention relates, in general, to automation and control systems, and, more particularly, to software, systems and methods for implementing a user interface for home automation systems that adapts to a variety of controlled devices of various manufacturers.

2. Relevant Background

Home automation systems enable control of lighting, heating and air conditioning, window shades or curtains, pool heaters and filtration systems, lawn sprinklers, ornamental fountains, audio/visual equipment, and other appliances. Home automation systems include relatively simple systems that control one or a few functions in a home to more elaborate systems that control multiple, disparate features. Home automation systems may be integrated with a home security system so that when a fire alarm is raised, for example, internal and external lights will be turned on. Entertainment equipment such as audio, video, and home theatre equipment are available with control interfaces that enable a remote device to activate the equipment according to programmed schedules or remotely input commands.

In general, a home automation or control system comprises one or more controlled devices, one or more controllers, and a command communication link coupling a controller to a controlled device. The controllers may be directly programmable in which case they include some form of human interface for setting switches, event timing, and the like. Alternatively, controllers may be indirectly or remotely programmable in which case a separate human interface may be implemented by a personal computer or the like. Systems may be programmed using either a simple command language or using a graphical user interface that requires a computer with a monitor. These systems are expensive and require substantial investment by the user in time and energy to install and modify programming. To enter and/or change a program, a user must consult a user's manual or call a programming specialist. Hence, these systems are difficult to install and adapt to changing needs. Moreover, they are difficult to expand by adding new controlled devices or new software to add functionality.

The home automation market has been fractured because most of the automation control manufacturers address narrow, vertical market segments, and use proprietary interfaces to protect their market. For example, some leading control manufacturers offer systems that focus on heating, ventilation, and air conditioning (HVAC) systems control. These manufacturers have little interest in controlling lighting, security systems, entertainment systems, and the like as these markets are entirely foreign to them. Other manufacturers make, for example, home entertainment controllers that integrate various video and audio components, but the primary focus has been to offer integrated control over only their own components. As a result, consumers face an array of control systems that do not interoperate, and that have proprietary interfaces that are difficult to understand and program. Moreover, the interfaces are inconsistent with each other in the manner in which controls are accessed, displayed and operate so that a user must learn the unique interface features of each control system. Hence, as more controlled systems are added, the complexity for the user increases significantly as new control interfaces must be added and learned.

Some efforts have been made to provide integrated interfaces—single devices that “talk” to various control systems in a residence. One available system offers a rigid architecture that is easy to install because it offers few customization options, however, the rigid architecture limits its functionality. Other systems offer more flexible interfaces, but in each case the implementations include limitations that make the products expensive and/or difficult to install. Further, the greater flexibility has a tendency to make the interfaces more difficult to use. A typical interface may be a numeric keypad, for instance, that requires the user to learn and remember what each of the keys or sequence of keys controls. Alternatively, users will attach labels to the keys to indicate what is controlled, which a useful but unsightly expedient. Accordingly, a need exists for a control system architecture that supports both flexible, but easy to learn and operate user interfaces.

Server-based control systems involve a central control mechanism or server that issues commands to each of the controlled devices either directly, or through subordinate controllers. Server-based systems may be easier to program as the operator may need to become familiar with a single program, but are more complex to install as each of the controlled devices must be coupled to and in communication with the central server. The central server may implement a graphical programming environment to ease programming, however, user interfaces that enable users to operate controlled devices tend to remain non-graphical (e.g., switches and keypads). Moreover, because the server must be programmed to interact with the various controlled devices and/or subordinate controls, the operator must still become intimately familiar with the protocols and vagaries of each controlled device, defeating the advantages of a single software interface.

Another common limitation of control systems arises from the control interface of the controlled devices themselves. A typical controlled device will implement a single control interface for receiving commands from a controller. This single interface is usually restricted to a single signaling protocol that makes a subset of the controlled devices functions accessible to the controller. Hence, the controlled device is designed to interact with a single controller and is unable to interact with a plurality of controllers.

Further, the functionality that can be implemented is restricted by the controller hardware and/or software and cannot be readily extended.

Hence, a need exists for a home automation and control architecture that is easy to install, easy to use, and at the same time flexible and extensible to accommodate new devices and new functionality.

### SUMMARY OF THE INVENTION

Briefly stated, the present invention involves a home automation and control architecture that includes one or more controlled devices and one or more control panels coupled by a communication network. Each of the controlled devices is directly coupled to at least one control panel and configured to communicate control information with the coupled panel. An inter-control communication path couples each of the control panels such that any one of the control panels can effect control over any of the controlled devices by communicating through another control panel that is directly coupled to a specific device.

In another aspect, the present invention implements discovery processes in at least one of the control panels where the discovery processes interrogate other control systems and subsystems. Specifically, the discovery processes operate to interrogate controlled devices and subsystems to learn device-specific signaling protocols for communicating control information with the interrogated systems and subsystems. User input is translated to the learned signaling protocol appropriate for a particular control system or subsystem to which the user input is directed.

In another aspect, the present invention comprises an automation system having an “open architecture” that supports standard communication protocols to transport communication with a variety of networked devices irrespective of the particular command interface and instruction/command architecture implemented by that device. An automation system will include a plurality of subsystems where at least some of the subsystems have disparate command interfaces. One or more controllers implement interfaces for communicating with the disparate command interfaces. The one or more controllers also implement a common user interface.

In yet another implementation the present invention involves an automation and control system which includes a message broker component. A plurality of network connected nodes implement interfaces for handling command communication, including control messages and status messages, with controlled devices. At least one message broker is coupled to receive command messages and direct received command messages to a selected node, wherein the node is selected based on that node's ability to handle the command message. In this manner, the message broker enables inter-node communication that hide the physical installation details from a node user. In another implementation, the message broker selects nodes based on current context information related to the nodes such that commands can be routed based upon the context of a node sending the control message and/or context of a node selected to implement the command message.

### BRIEF DESCRIPTION OF THE DRAWINGS

FIG. 1 shows an networked control environment in which the present invention is implemented;

FIG. 2 illustrates a hardware-oriented view of a control panel device in accordance with the present invention;

FIG. 3 illustrates a logical view of processes implemented by a control panel device in accordance with the present invention;

FIG. 4A-4E show exemplary user interface views illustrating operation of the present invention; and

FIG. 5 illustrates in story-board format an exemplary screen flow illustrating transitions of a user interface in accordance with the present invention.

### DETAILED DESCRIPTION OF THE PREFERRED EMBODIMENTS

In general the present invention relates to a control architecture that distributes control information such as device commands and status information between human interface units, referred to as control panels, and controlled devices. The device commands typically relate to operational commands to turn on/off a controlled device, adjust settings on a controlled device, query the status of a controlled device, and the like. Status information typically relates to current operational state of a controlled device, maintenance status of the controlled device, and the like. Moreover, the architecture of the present invention enables the human interface units to access external information from virtually any source supporting standard network communications including local area network resources, wide area network resources, Internet resources and the like. These types of resources have, until now, been unavailable to automation control systems.

The present invention is particularly useful in home automation environments because it builds on top of the vast array of controlled devices and subsystems that already exist for managing lighting, security systems, heating and air conditioning, window shades or curtains, pool heaters and filtration systems, lawn sprinklers, ornamental fountains, audio/visual equipment, and other appliances. Hence, while it is contemplated that the present invention may be adapted to handle special-purpose and proprietary controlled devices and subsystems, a particular advantage is that the present invention adapts to existing controlled devices and subsystems and leverages their advantages.

In essence, the present invention provides a control system architecture that abstracts the human interface organization from the physical interconnection to controlled devices. This enables a configurable many-to-many relationship to exist between controllers and controlled devices, greatly easing installation of a home automation system. In an exemplary installation, the controlled environment is defined by a series of linked screens so that each screen can include design elements, buttons and controls that represent the controlled environment in a contextually relevant fashion. This architecture is rigid enough to provide a consistent, predictable installation, but flexible enough to allow easy expansion and accurate representation of the environment, even dynamically changing environments.

The present invention is illustrated and described in terms of a distributed computing environment having nodes distributed throughout a building. However, an important feature of the present invention is that it is readily scaled upwardly and downwardly to meet the needs of a particular application. Accordingly, unless specified to the contrary the present invention is applicable to significantly larger, more complex network environments such as wide area networks (WANs), as well as small network environments such as conventional local area networks (LAN) systems or non-networked environments.

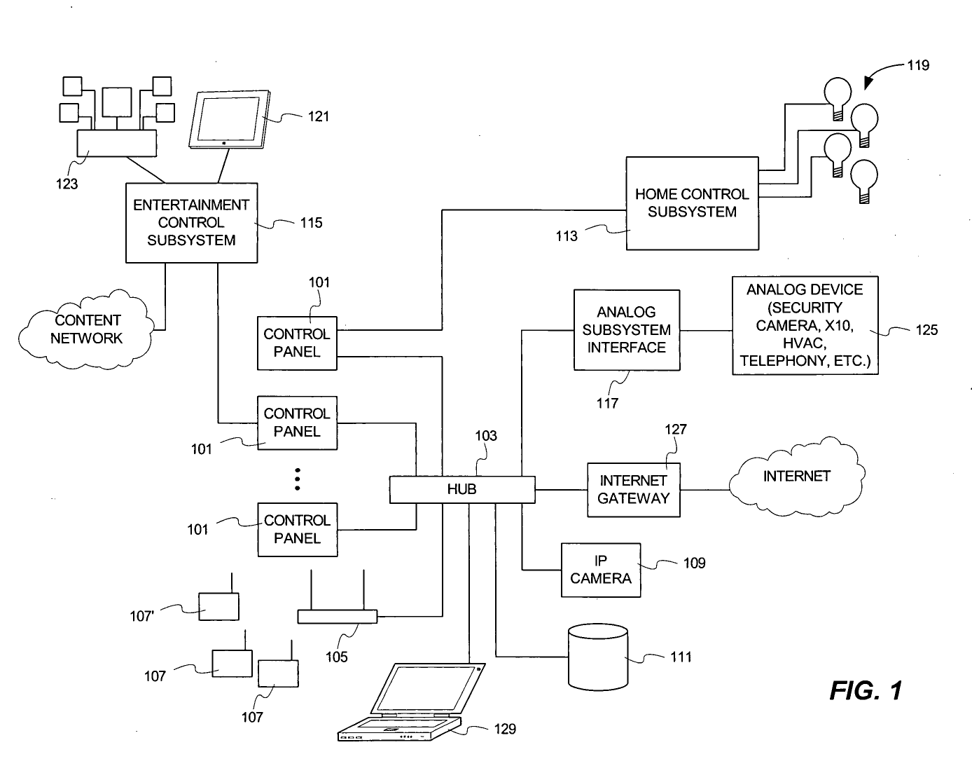

FIG. 1 shows an exemplary control environment in which the present invention is implemented. A plurality of control panels 101 implement a programmable human interface in the particular embodiment. Control panels 101 are conveniently implemented using computer industry standard components and software to the extent practical, although special purpose, non-standard components and software are a suitable equivalent in particular applications. In a particular example, control panels 101 comprise variants of a personal computer (PC) architecture to take advantage of price and performance features of the personal computer market. Control panels 101 are mounted throughout a building at locations where it is convenient or desired to exercise control over controlled systems. For example, a control panel 101 can be provided in each bedroom of a house, as well as a kitchen, office, entertainment areas and the like. Alternatively, one or two control panels 101 may be provided in central locations for shared access by all members of a household.

As a particular example, the Companion™ 6 and Companion™ touch-screen interface units produced by CorAccess Systems of Golden, Colo., assignee of the present invention, are suitable implementations for control panels 101. These devices implement a touch-screen graphical user interface and are compact flat screen devices that are readily wall mounted. These devices have suitable computing power and resources to implement a variety of applications for exercising home automation and control functions contemplated by the present invention.

A hub 103, such as a conventional Ethernet/network hub, provides a network interconnection between control panels 101 and other devices. Hub 103 may be implemented as a hub, router, switch, access point, or similar device that couples network devices. While Ethernet transport is used in the particular implementations described herein, other standard and/or proprietary transport mechanisms such as RS-232, RS-485, IEEE 1394, IEEE 802.11, and the like are suitable substitutes. Moreover, while the particular examples use an IP protocol, other protocols such as NetBIOS, AppleTalk, and the like may be appropriate in particular installations. Hub 103 may implement any number of ports to meet the needs of a particular application, and may be implemented by a plurality of physical devices to provide more ports and/or a more complex network including sub-networks, zones, and the like.

In addition or alternatively, the present invention may be implemented using wireless networking components such as a wireless access point/router 105 and wireless control panels 107. When used in combination with a wired network, access point 105 may be coupled to the network via hub 103. Alternatively, access point/router 105 may implement the hub/router/switch functionality to replace hub 103 altogether. Wireless control panels 107 implement similar functionality to control panels 101 and may be implemented by devices such as a Mobile Companion™ or Mobile Companion™ X available from CorAccess Systems. Wireless control panels 107 may also be implemented by a variety of wireless general-purpose computing devices such as laptop computers, handheld computers, palm computers and the like as well as special purpose devices provided in the form of, for example, remote controls, key fobs, smart cards, and the like. It is also contemplated that a wireless control panel may be implemented without an integrated graphical display, and instead use a detached display such as a television to implement a graphical user interface. This implementation would allow a control panel to be quite small as would be convenient for a handheld device.

Yet another type of client, a virtual client 107′, may implement relatively lightweight processes that essentially emulate a control panel interface, and other processes that couple to a control panel 101. This is desirable when using some handheld computing devices for the virtual client as the handheld device can receive user commands and display status messages, but more computationally intense tasks are implemented in a control panel 101. Moreover, the virtual client 107 may be implemented in any computing device (e.g., a work personal computer, handheld computer) that is not connected to the home network to provide the user interface features without requiring installation of the entire system.

Several basic types of controlled devices are shown in FIG. 1. First, controlled devices may be directly connected to the network via, for example, hub 103. For example, an IP camera 109 comprises a camera that implements its own IP interface. A variety of security, telecommunications, environmental sensors, and the like are available with suitable IP interfaces. These controlled devices communicate control messages with a network-coupled control panel 101 or 107.

A second type of controlled device is coupled to a particular control panel 101/107 through a subsystem interface. For example, one control panel 101 couples to a lighting control subsystem 113 while another control panel 101 couples to an entertainment control subsystem 115. The subsystem interfaces comprise, for example, a control device that is provided with a particular third-party subsystem that may have a special-purpose or proprietary signaling protocol. The control panel 101 couples to the subsystem interface using the physical, electrical, and signaling protocols adopted by that subsystem. For example, a serial connection such as an RS-232 or RS-485 connection is used in many cases.

Alternatively, a subsystem interface may couple with hub 103 such as the case with analog subsystem interface 117. A variety of controlled devices are available such as security cameras, landscape controllers, telephony devices, HVAC systems, and the like that do not communicate using standard computer protocols. An analog subsystem interface 117 implements control functions to the extent possible with such devices and provides a network interface for coupling to other systems. An example of such a system is a variety of X10 devices and controls marketed by X10 Wireless Technology, Inc. of Seattle, Wash.

The present invention also contemplates implementing shared services (e.g., telephony, Internet access, and the like) and/or resources such as shared mass storage 111 through an internet gateway 127. Mass storage 111 may be coupled via hub 103, or may be directly coupled to one or more control panels 101/107. Internet gateway 127 may couple to hub 107 or may be integrated with hub 103 when implemented as a router or access point. Internet gateway 127 may implement a hardware and/or software firewall or other access control mechanisms for increased security.

Optionally, one or more conventional personal computers 129 may be coupled to the network as well via hub 103 and/or wireless access point 105. In addition to implementing function similar to control panels 101/107, a personal computer 129 may implement applications that are not installed on or readily executable by control panels 101/107. Additionally, personal computer 129 may implement common applications and/or computationally intensive applications such as word processing, web browsing, database access, and the like using conventional software.

In operation, the system shown in FIG. 1 enables controlled many-to-many access between each control panel 101/107 and any of the controlled devices or subsystems. In prior home automation systems an entertainment control system was essentially stand alone, and could be accessed through a dedicated human interface that enabled control over audio equipment 123 and video device 121. A separate, independent system with a separate human interface would be required to control lighting, or security systems, for example.

In contrast, the present invention enables any control panel 101/107 (or PC 129) to send a control message relevant to any particular controlled device. Each control panel 101/107 is aware of controlled devices and subsystems that it can directly access, and implement a message broker process that listens for control messages relevant to those devices/subsystems. The message broker is able to generate command and control messages directed to any other control panel 101/107 as well as respond to command and control messages from other control panel 101/107.

In this manner the message broker processes enable each control panel 101/107 to act as a server, which has distinct advantages over centralized server systems. For example, the system can continue to function in the event of failure of one control panel or the link to a control panel. The server programs (e.g., the message broker and the HTTP server) can support “client” processes within the control panel or from other control panels in a unified fashion.

The message broker server processes interpret the command messages and generate appropriate device-specific signaling to implement a command on the controlled device or subsystem. Similarly, status signals from controlled devices are interpreted and the message broker process generates network-compatible control messages that are distributed to the control panels 101/107. In this manner, any control panel 101/107 can communicate control information with any controlled device or subsystem without requiring detailed knowledge of the particular interface and signaling requirements of that controlled device or subsystem.

Another feature of the present invention involves system discovery processes implemented in control panels 101/107. When a control panel 101 is coupled to a controlled device or subsystem, it interrogates that device or subsystem to learn details of the control interface of that particular system. Many special purpose subsystems support such interrogation to various degrees, and such interrogation will often provide sufficient detail to enable full access to even proprietary control interfaces. This interrogation may simply be a matter of determining the controller type in which case the control panel 101 can look up a command set and signaling protocol information for that controller type. Alternatively, the interrogation may reveal more details about actual commands that are available. In some cases, a controlled device or subsystem will return insufficient information during interrogation in which case the control panel can be manually or semi-automatically programmed to support that controlled device or subsystem.

Because control panels 101/107 speak a common language amongst themselves, once a single control panel 101/107 discovers a particular controlled device or subsystem, that information can be readily shared (when desired by the users) with any other control panel 101/107. In most cases it is not necessary for every control panel 101/107 to have detailed knowledge of a particular controlled device or subsystem. Instead, it is sufficient to be aware of the existence of each controlled device and the functionality available from that device. For example, details of entertainment control subsystem 115 are often not important so long as information about audio system 123 and its functions (on/off, signal source, volume control, status, etc.) are made available.

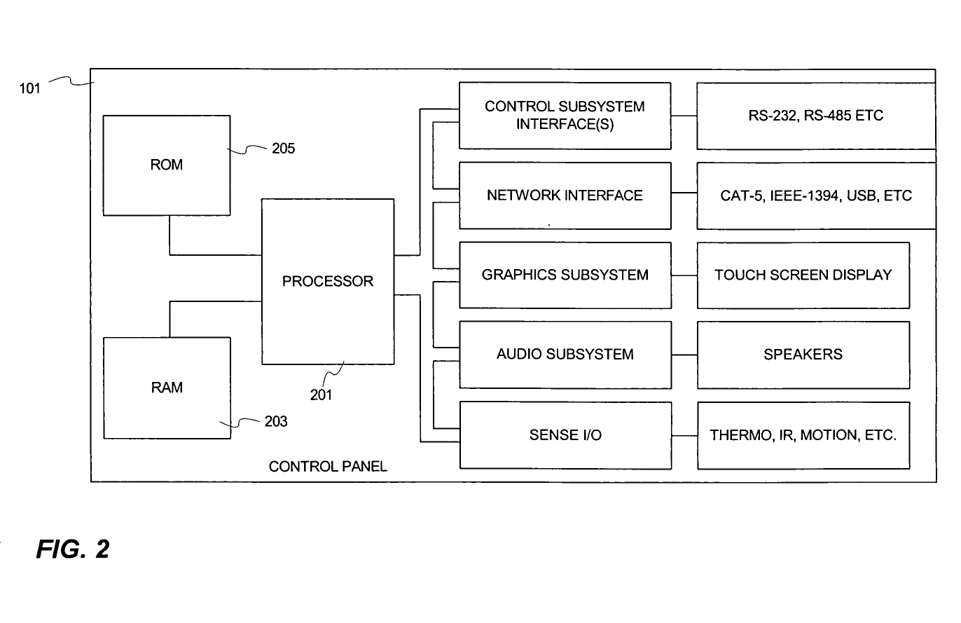

FIG. 2 illustrates a hardware-oriented view of a control panel 101 in accordance with the present invention. A control panel 101 is powered by AC or DC power source although power supply and distribution are not shown in FIG. 2 to ease understanding of the present invention. A processor 201 implements data processing functionality for accessing and manipulating data from various subsystems and memory. Memory such as random access memory 203 and/or read only memory 205 may be provided as separate devices or integrated with processor 201. Processor 201 may be implemented, for example, by a Pentium® class processor provided by Intel Corporation, or the like. By using general purpose, widely available processor components a wide variety of operating system and application software is available, and new applications are easily developed. Alternatively, some processor architectures such as the Super-H licensed by SuperH, Inc. and StrongArm processors provided by a variety of manufacturers support integration of various functions such as serial interfaces, network interfaces, graphics subsystems, audio subsystems, and the like which may provide cost and/or performance benefits in some applications.

The various subsystems shown in FIG. 2, including serial interfaces, network interfaces, graphics subsystems, audio subsystems, and sensor I/O, are exemplary only as additional subsystems may be useful in some applications, whereas some of the illustrated subsystems may not be required. Processor 201 is coupled to various subsystems using any available connection technology such as a peripheral component interconnect (PCI) bus or the like.

Control subsystem interface(s) comprise one or more interfaces that support connection and communication with subsystems 113 and 115 in FIG. 1. These would be typically implemented as serial interfaces coupling to, for example, an RS-232, RS-485, and/or universal serial bus physical connections. Any number of such interfaces may be provided in a control panel to meet the needs of a particular application. A network interface implements the resources required to support packet communication over, for example, a CAT-5, EEEE-4 or USB connection, for example. These functions are substantially similar to what might be found in a convention personal computer network interface card (NIC).

A graphics subsystem preferably supports an LCD panel display and touch-screen functionality. Alternatively, other graphical user interface I/O technology can be substituted in particular applications. LCD panels provide low power, convenient displays with long life and form factors that are amenable to wall mounting, and so are desirable in many applications. In applications where a GUI is not desired, a graphics subsystem can be greatly simplified by substituting driver electronics for LED and push-button human interface components.

Optional audio subsystem may be provided to drive integrated speakers. Similarly, some sensory I/O may be desired to sense room temperature, or motion detectors to sense activity in proximity with a control panel 101. Sensory I/O may be omitted where desired, or provided through a serial connection, or provided through the network in a manner similar to other controlled devices and subsystems.

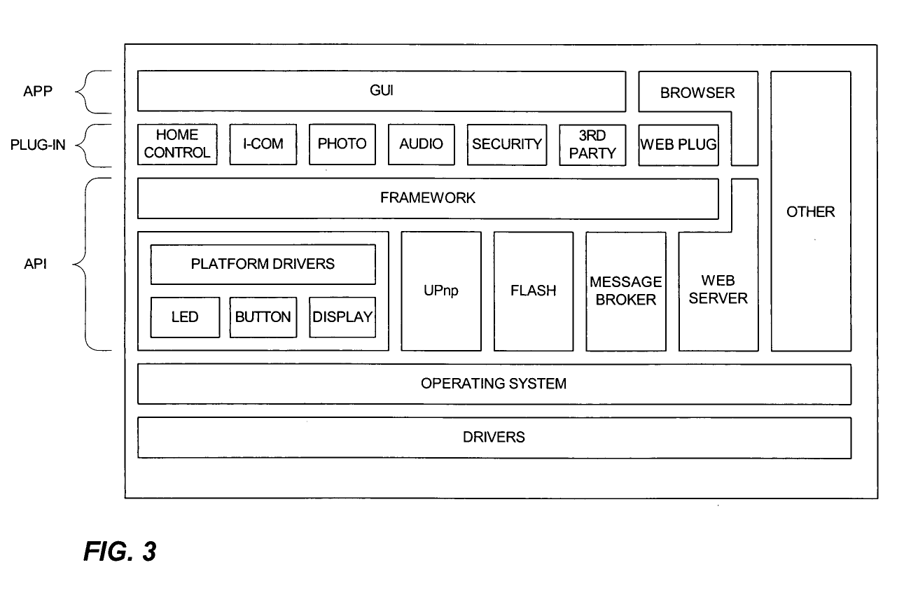

FIG. 3 illustrates a logical view of processes implemented by a control panel 101 device in accordance with the present invention. The drivers layer interfaces with the various hardware components shown in FIG. 2. Drivers may be added and removed from the drivers layer to support additional or updated functionality. Operating system layer may be provided by any available operating system, although it is useful to have an operating system that has a relatively small resource consumption such as Linux, Windows CE® or the like.

The application programming interface (API) layer comprises various processes that provide access to OS services and augment OS services for use by particular applications. Universal Plug-and-Play (UPnP™) processes support common protocols and procedures intended to enhance interoperability among network-enabled PCs, appliances, and wireless devices. Flash processes implement services related to Macromedia® FLASH programming environment and extensions. The particular implementation also includes web server processes such as provided by Xitami® web server products. The web server processes support a browser-based graphical user interface using reliable and scaleable software that is readily configured to access other processes and resources. Further, web server processes support software updates well.

Platform drivers are similar to hardware drivers, but offer more complex and platform specific functionality for devices such as hardware switches, LED indicators, and an LCD display. In particular implementations, the API layer includes driver libraries for accessing and operating hardware functions that are somewhat unique to a particular control panel 101/107. By making these drivers accessible to application plug-ins, the tasks involved in developing new plug-ins are greatly simplified. It becomes unnecessary to have intimate, detailed knowledge of how to turn on an LED or detect a switch activation, for example, because the built-in driver library can handle the details of these tasks.

An important feature of the API layer is a message broker that provides services that coordinate communication between the various other API layer and application layer processes. The message broker component includes processes for listening to control messages, including command and status messages, and parsing those messages to determine which processes, if any, in that control panel 101/107 are involved in handling the control message. For example, a control message that is received externally and indicates a command to sound an alarm at that control panel 101 will be passed to an audio and/or security application plug in. A command message relating to turning on/off a light fixture may be passed to a home control plug in, or may be ignored if it relates to a fixture that is not coupled to that control panel 101. Similarly, a status message indicating that a light fixture is turned on may be formed into a message directed to one or more other control panels 101/107 that have interest in the status of that light fixture. The message broker can use, in particular embodiments, available mail protocols and the like to send notifications to external systems or recipients as well as communicating in-network messages to other control panels 101/107. These notifications can be used to convey information about events (e.g., a security alarm trigger), as well as system status (e.g., a communication failure with a control panel 101/107 or failure of a HVAC subsystem).

Sophisticated configurable functionality is implemented by application layer and plug-in components. In a particular configuration, control panel 101 implements a native GUI that interfaces with various special-purpose plug-in components. Each control panel 101 may have a distinct set of plug-in components to meet the needs of the particular room or environment where the control panel 101 is installed. Further, the set of plug-in components can be changed based on specific user preferences. For example, a children's room may not normally use access to a home security system, however, when that same room is used as a guest room security system access may be enabled by installing a security plug-in. Similarly, the functionality of each component can be altered to increase or decrease the functionality based on the current user of the control panel, or the time of day, or other configurable permissions basis.

Exemplary plug-in components include a home control component that is designed to interface with one or more controlled devices or subsystems. An intercom plug-in provides intra-building communications and/or interface to a telephony system. A photo plug-in handles accessing and displaying photographs, video, or other content while an audio plug-in enables controls that can play audio files on the control panel 101 and/or control audio equipment 123 shown in FIG. 1. Security plug-in monitors status of a home security system and may enable features of the security system to be enabled/disabled under user control or programmatically. Any number of third party plug-ins are possible to implement extended functionality and/or enable access to new types of controlled devices and subsystems. Third party plug-ins are designed to comply with the API layer, or in some cases may interact with the operating system directly as suggested by the component labeled “OTHER” in FIG. 3.

Various plug-in components are enabled to communicate with each other through the message broker component as well as communicating with other control panels 101/107 and controlled devices and subsystems. For example, a security plug-in may monitor status of a home security system and when an anomaly is detected, activate the audio and home control plug-ins to provide information and/or alerts to users.

Moreover, the security plug-in may override and close certain applications such as a photo player plug-in or audio plug-in to disable activities that might distract from the security plug-in's activities.

Optionally, a browser user interface is provided to supplement the native GUI interface. So much software and plug-in functionality is available for common browser GUIs such as Mozilla, Internet Explorer, and the like that it may be useful to provide a browser interface and web plug ins to perform certain functions that augment and/or replace various other plug-ins. It is contemplated that a system may be provided that will eliminate the native GUI and plug-ins entirely and use only a browser interface with a suitable plug in to the API via web server processes in the API.

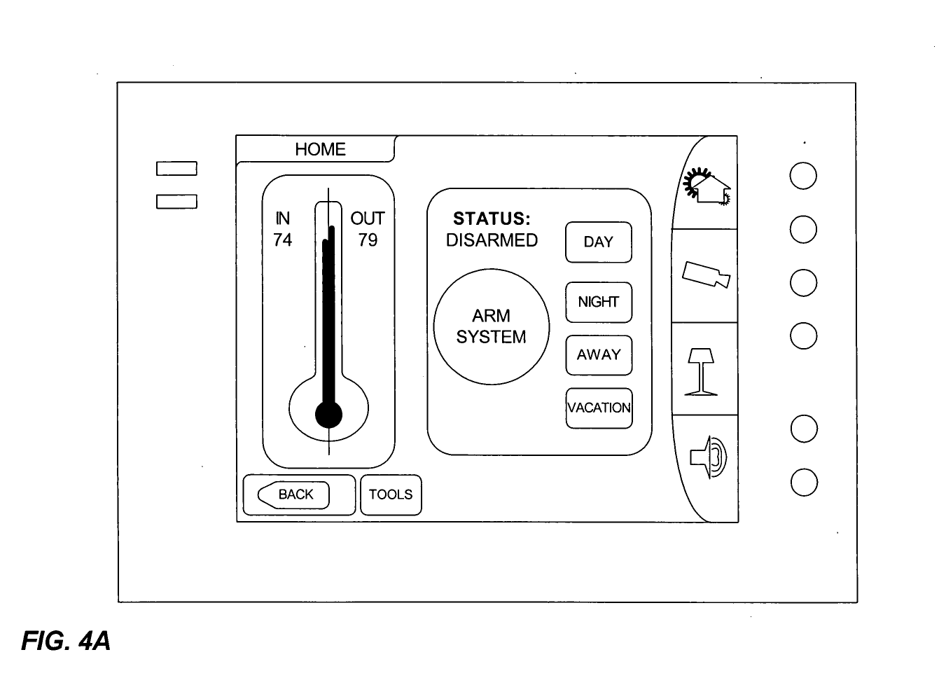

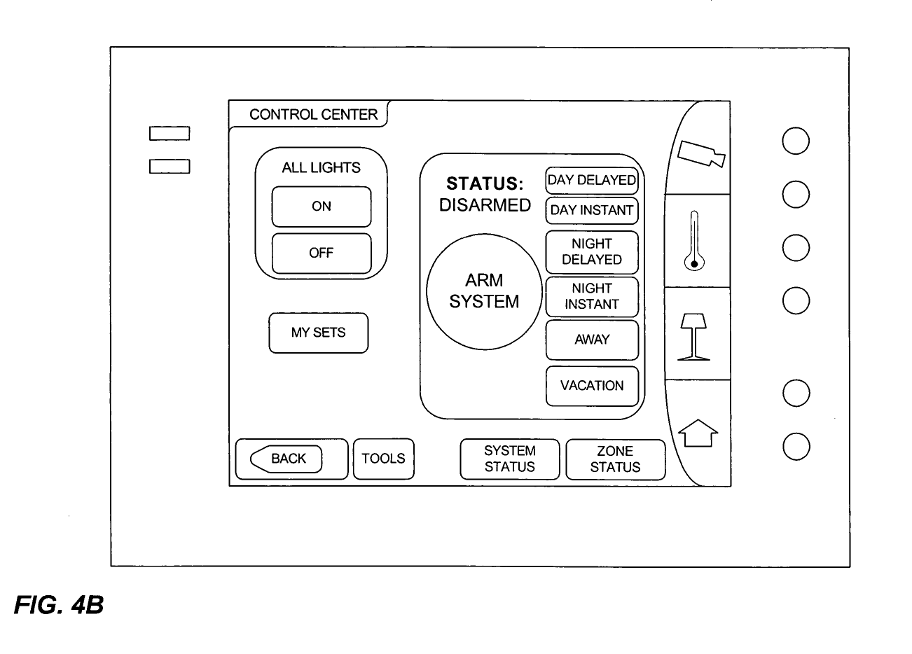

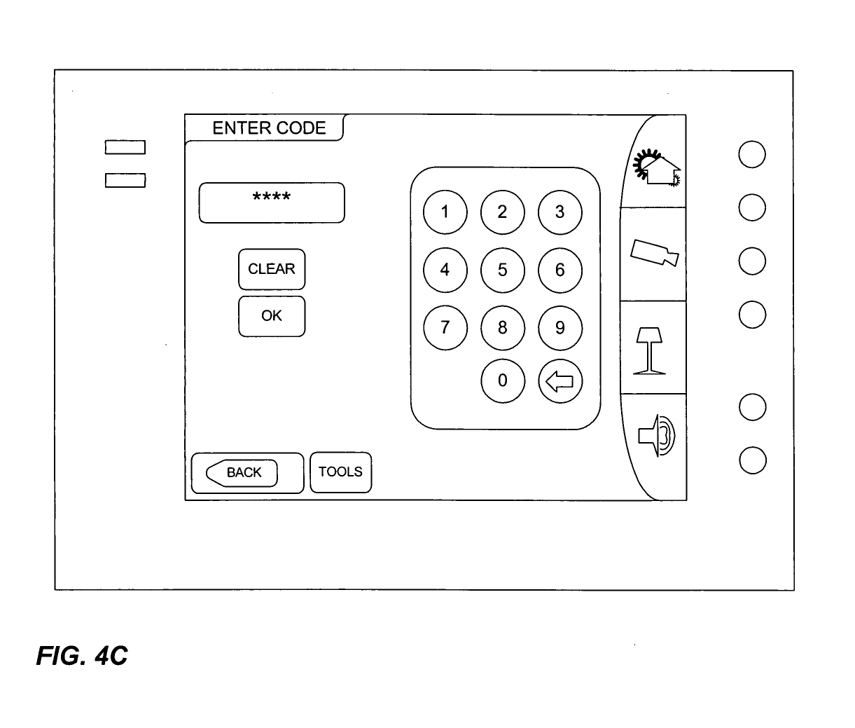

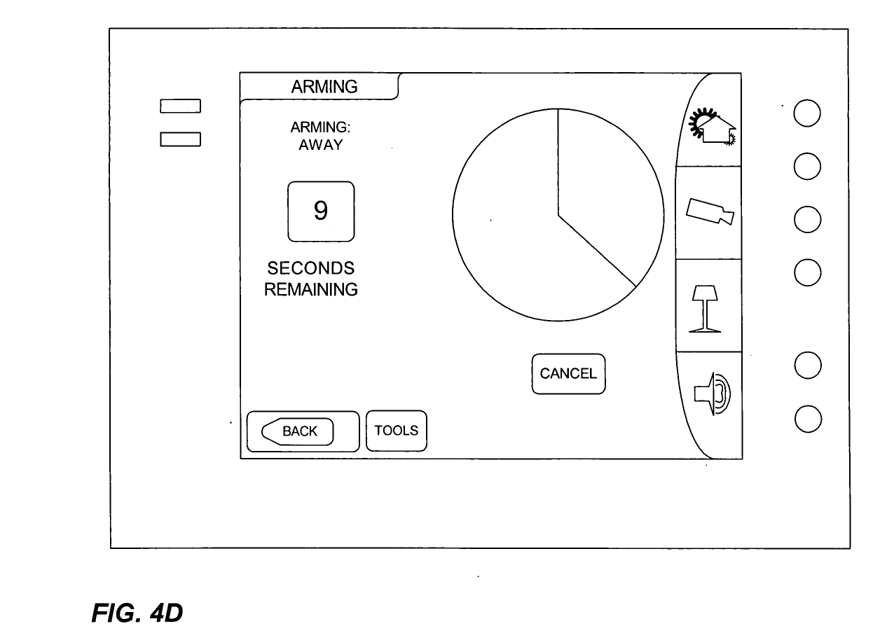

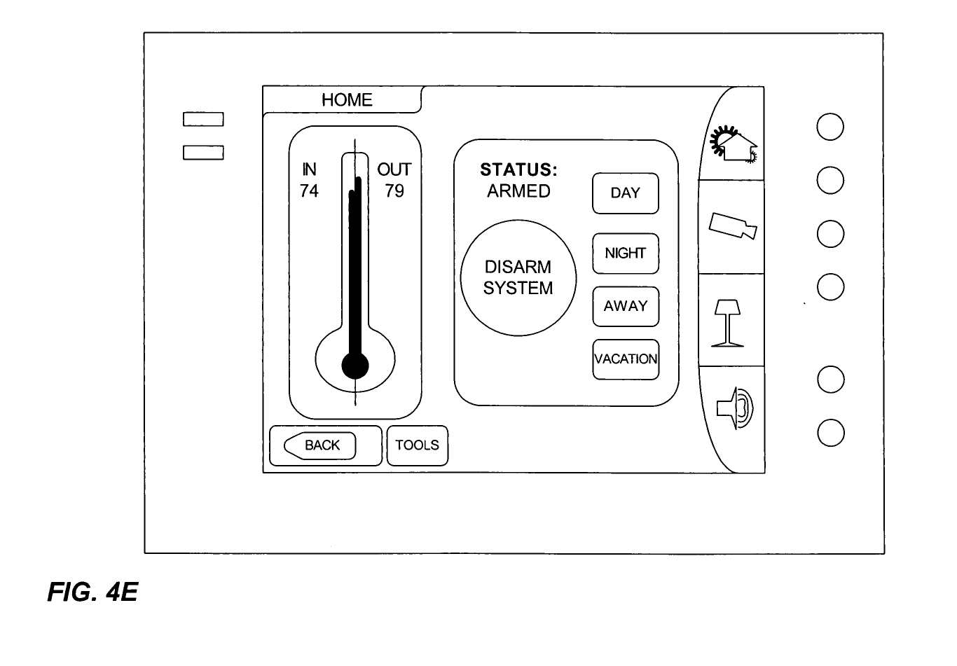

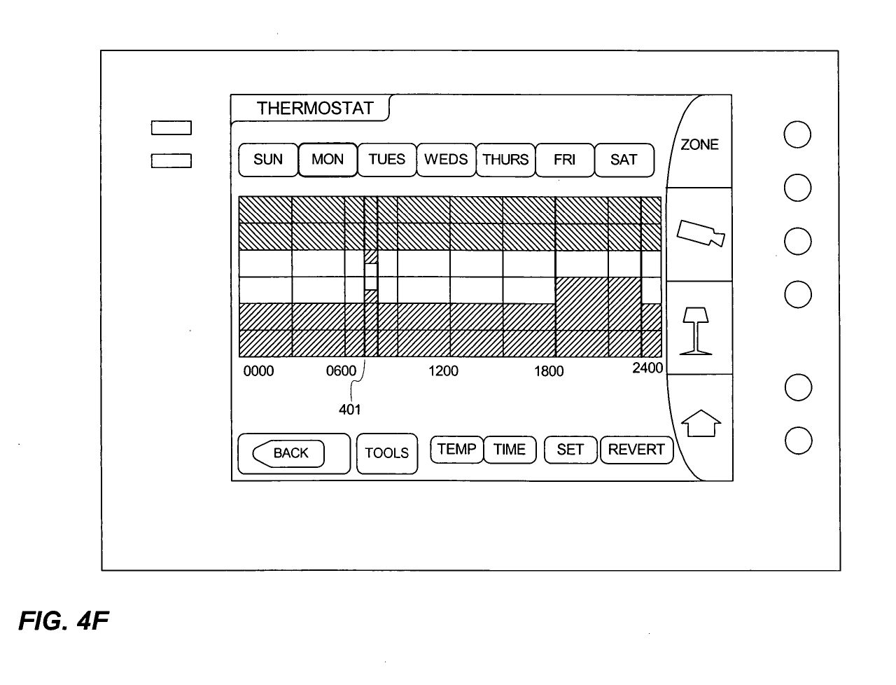

FIG. 4A through FIG. 4E (F) illustrate a series of screen displays implemented in a particular embodiment of the invention. It should be understood that the variety and composition of the screens, as well as the flow from screen-to-screen, is readily adapted to meet the needs of a particular application. Each screen includes a number of graphical and design elements that may be static or animated (i.e., change over time). Some of the elements indicate status of the system or of a controlled device or subsystem. Others of the elements are controls or buttons that generate messages to other control panels 101, generate messages to controlled devices or subsystems, or initiate a transition to a new screen. In the particular implementation, a common design theme is presented across the various screens shown in FIG. 4A through FIG. 4F so that the user is presented with a familiar, consistent environment across the various functions. At the same time, the functionality of certain controls will change from screen-to-screen and screen-specific controls are provided so that each screen reflects a contextually relevant view of the control functions. The various controls can be selected and operated using a pointing device or by touch screen inputs.

FIG. 4A shows a “home” screen that would be, for example, the normal state of a control panel 101 from which other control functionality can be reached. The exemplary home screen includes a thermostat display indicating room temperature and/or outside temperature, either of which may be measured by the control panel 101 itself, or be obtained from a remote device or other control panel 101. The home screen also includes a display of the security system status, which in FIG. 4A is not armed. The security system status includes various control buttons labeled “day”, “night”, “away” and “vacation” that are used to transition to other screens used to program and operate the security system.

Common user interface elements include a series of buttons on the right-hand side of the display that initiate a transition to other screens. For example, the upper button iconically indicates a “control center” and when operated will cause a transition to a control center screen shown in FIG. 4B. A thermometer icon identifies a button that initiates a transition to a HVAC control screen. A lamp icon identifies a button that initiates a transition to a lighting control screen, while a speaker icon identifies a button that initiates a transition to the media control screen. The choice and selection of the buttons to be displayed on the home screen is readily adapted to a particular application, and those shown in FIG. 4A are provided for illustration only. Desirably, each screen includes some navigational buttons such as the “back” button in FIG. 4A. Also, each screen may provide a “tools” button that initiates a transition to a screen used to configure and manage the system and/or control panel 101 itself (e.g., adjust contrast, update software, and the like).

Upon activating the control center button in FIG. 4A, the control center screen shown in FIG. 4B is presented. As can be seen by comparison of FIG. 4A and FIG. 4B, there is a common design theme between the screens, although each screen presents a contextually relevant set of controls. For example, the control center screen no longer needs to display a control center button, and so that button is “replaced” with a button bearing a “home” icon which, when activated, initiates a transition back to the home screen shown in FIG. 4A. The control center screen provides controls and display graphics showing a different set of detail and enabling a different set of functionality than the home screen shown in FIG. 4A.

Upon activating the “away” button in either FIG. 4A or FIG. 4B a series of screens related to activation of a security alarm is initiated. In FIG. 4C, an “enter code” screen is presented to prompt the user to enter a security code in addition to a number of “standard” controls located in the right hand side of the screen. Again, the set of standard controls presents a consistent design with respect to placement and graphics, but some of the control functions may change to present controls that are more relevant to the context of entering a pass code to arm a security system. FIG. 4C illustrates the great flexibility enabled by the graphical display of the present invention in that a familiar numeric keypad is implemented for entering a security code. The numeric keypad is not useful for many other functions such as turning on lights or playing music, but it is contextually relevant to the task of arming a security system. Similarly, alphanumeric or symbolic keypads may also be presented as desired. When a proper code is entered, the entry may be validated against a stored code by the security subsystem, or may be validated using processes within the control panel 101 itself. In this manner, the present invention can both extend existing security features as well as implement security features that do not exist in the underlying controlled system.

Upon entry of a valid code, the system transitions to the “arming” screen shown in FIG. 4D. Again, the arming screen includes very contextually relevant information including graphical elements that clearly communicate that the alarm system is arming. Because the control panel 101 can present programmable, animated graphics, it becomes possible to present information, like an alarm countdown, using graphical techniques not possible in prior systems. FIG. 4D illustrates that in many automation tasks, the user interface requirements for entering information may vary significantly from the user interface requirements for displaying status information. Prior systems were forced to compromise to make a single interface that served both functions. However, the present invention allows the screen to retrain common, contextually-relevant features while altering components as needed to support both entering and displaying information. Upon activation of the alarm, the system transitions back to the home screen in the particular example. However, the home screen now appears as shown in FIG. 4D with updated information concerning the alarm status. Additionally, some elements may change color, size, or shape to indicate the new status graphically. For example, the disarm system graphic appears red in the particular example whereas the “arm system” graphic appears green in FIG. 4A.

FIG. 4F illustrates another screen that relates to thermostat and HVAC scheduling, a common home and office automation task. In the particular implementation, the screen shown in FIG. 4F is reached by touching the thermometer graphic on any screen, but may be linked to by other paths as well. Unlike merely setting a thermostat, HVAC scheduling is a somewhat complex task as it involves numerous set points that may change over time for both cooling and heating systems. The familiar programmable thermostat in many homes allows a user to define time spans during a day or week, then to apply thermostat settings to each time span. Other systems use alphanumeric keyboard entry to define time spans and thermostat settings. These devices do not enable a user to visualize the settings over a span of time (e.g., a day) which makes the task more difficult. Moreover, keyboard entry of program settings is laborious and difficult to adjust as desired.

In the screen of FIG. 4F, the scheduling task is benefited by both the graphical display of information, and the ability for users to manipulate and enter data using the graphical screen. For example, spans of time can be defined by touching and dragging vertical indicators 401. Temperature set points can be established in any of the zones by dragging the color bars to a desired level within the zone. Prior automation system user interfaces can not or do not enable users to interact in this graphical manner to actually enter scheduling information. A similar interface can be used with lighting, sound volume, and other controlled devices that the user desires to vary over time according to a schedule.

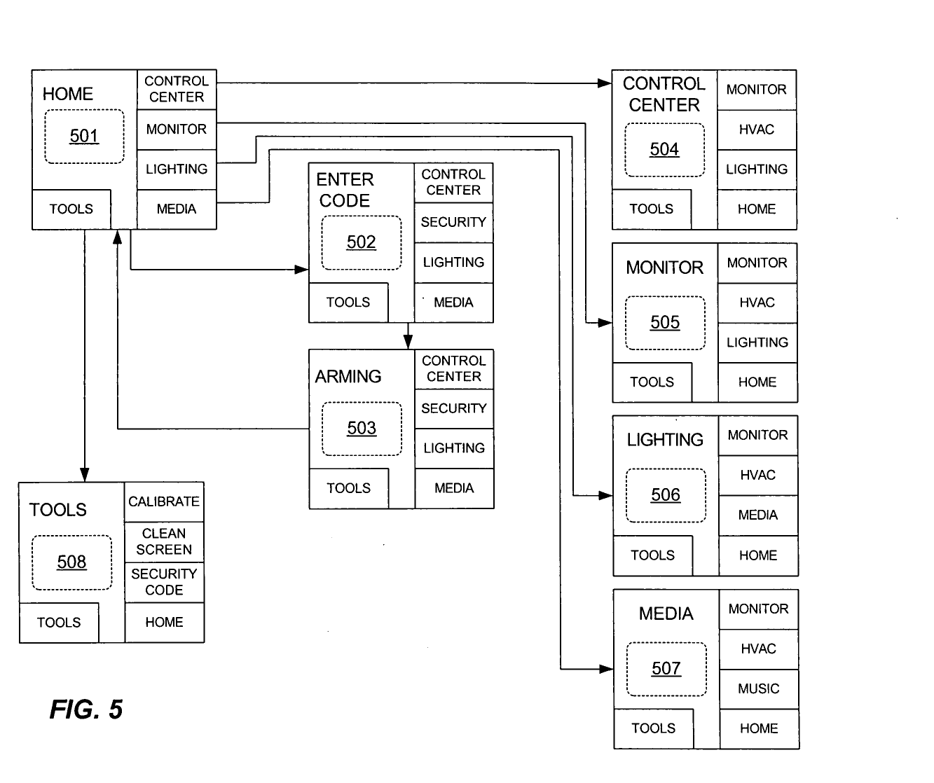

FIG. 5 illustrates an exemplary screen flow demonstrating how the present invention enables transitions from one screen to another screen in response to either user input or system events. A typical system may involve tens or hundreds of linked screens. Beginning with the home screen, each of the control center, monitor, lighting and media button initiate a transition to a particular screen. The user returns to the home screen by activating the “home” control on any given screen, or by system events such as a time out that cause a screen to automatically transition back to the home screen. The tools button initiates a transition to a tools screen that presents various tools for calibration, setting preferences, and the like. It should be apparent that not all of the screen-to-screen links are shown in FIG. 5 to ease illustration and understanding. For example, in any given screen a control labeled “media”, which is presented in many screens, would link to the media control screen shown in the lower corner of FIG. 5.

Each screen shown in FIG. 5 includes common design elements as well as screen-specific or context-specific portions 501-508. Each of these context-specific areas include controls that display context-relevant information and/or enable a user to select context-relevant functions which will in turn initiate any number of other screens. For example, context area 501 in the home screen includes a control that displays thermostat information and, when activated, launches an HVAC scheduling screen such as shown in FIG. 4F. Context area 501 also includes alarm system information indicating current status of the alarm system as well as control, which when activated, initiate a transition to the enter code screen as shown in FIG. 5.

The context area 502 in the enter code screen includes controls as described in reference to FIG. 4C and the arming screen includes controls as described in reference to FIG. 4D. Upon completion of the arming processes, the system initiates a transition back to the home page where the context-specific controls and graphics are updated to indicate the new state of the alarm system. This transition to the home page is an example of an “unsolicited” transition (i.e., a transition that is initiated by a system event or status change rather than by an explicit user input).

Referring now to the monitor screen, context specific area 505 includes a media player that displays input streaming from one or more monitor cameras such as IP camera 109. Exemplary controls that may be useful in this context include a control to switch cameras, move a camera, focus a camera, switch between tiled and non-tiled views of multiple input streams, record the camera view, and the like. The context specific area 506 of the lighting control screen may include controls for selecting various lights throughout a building, turning the selected lights on and off, dimming lights, and scheduling times for light-operations. The media screen includes a context specific area 507 that may include, for example, controls for selecting various media sources (e.g., music. CD, radio, or an external source, DVD, tape, television, slide show, and the like). These individual device selections will, in many cases, launch further screens that are specific to the operation of the selected device. The media screen in FIG. 5 also includes a control linking to a media library or other network attached resource for storing media files. As with the HVAC and lighting applications, the media screen may implement scheduling functions to record/play media files according to a schedule executed at one or more times in the future.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A home automation control system comprising:
a plurality of control panels;
a communication network coupling the plurality of control panels;
a plurality of controlled devices wherein each controlled device implements an interface for communicating control messages;
processes implemented within the plurality of control panels operable to generate command messages relevant to at least one of the controlled devices; and
processes implemented within the plurality of control panels operable to handle status messages relevant to at least one of the controlled devices.

2. The home automation control system of claim 1 wherein at least one controlled device is directly coupled to one of the plurality of control panels.

3. The home automation control system of claim 1 further comprising a process executing in at least one of the plurality of control panels operable to receive a message from the packet communication network, interpret the message.

4. The home automation control system of claim 1 wherein at least one of the plurality of controlled devices comprises a subsystem that implements a device specify signaling protocol with one or more other controlled devices.

5. The home automation control system of claim 1 wherein the plurality of control panels implement a plug-in framework that enables addition of plug-in software modules to define functionality.

6. The automation control system of claim 1 wherein the plurality of control panels each implement a set of plug-in software components independently of a set of plug-in software components implemented in any other of the control panels.

7. The home automation control system of claim 7 wherein the plug-in framework comprises a web server to support a web browser graphical user interface.

8. The home automation control system of claim 7 wherein the framework provides interfaces to hardware platform drivers accessing hardware features of the control panel.

9. The home automation control system of claim 7 wherein control panel implements a Macromedia Flash graphical environment and the framework provides interfaces to the Macromedia Flash graphical environment.

10. A control unit for a home automation system, the control unit comprising:
a processor;
memory coupled to the processor for storing data and programmed instructions;
a communication interface configured to coupled to external control subsystems;
a network interface configured to couple to other control units and exchange control messages with the other control units;
a plug-in framework executing on the processor; and
a plurality of plug-in applications coupled with the plug-in framework and operable to perform specific functions related to generating and responding to home control messages using the serial communication interface and network interface.

11. The control unit of claim 10 further comprising a built in library of platform drivers, wherein each platform driver implements specific functionality for controlling hardware on the home control unit.

12. The control unit of claim 10 further comprising discovery processes implemented in the processor, where the discovery processes interrogate other control systems and subsystem to learn device-specific signaling protocols for communicating control information with the interrogated systems and subsystems.

13. An automation system comprising:
a plurality of control subsystems where at least some of the subsystems have disparate command interfaces;
a control unit implementing a plurality of interfaces for communicating with each of the disparate command interfaces; and
a common user interface in the control unit for processing user commands related to each of the plurality of control systems.

14. An automation and control system comprising:
a plurality of network connected nodes each implementing interfaces for handling control message communication; and
at least one message broker is coupled to receive control messages and direct received control messages to a selected node.

15. The automation and control system of claim 14 wherein the selected node is selected based on that node's ability to handle the command message.

16. The automation and control system of claim 14 wherein the selected node is selected based on current context information related to the nodes such that commands are routed based upon the context of a node sending the control message and/or context of a node selected to implement the command message.

17. The automation and control system of claim 14 wherein the control messages include command messages and status messages.

18. The automation and control system of claim 14 further comprising a virtual control unit comprising computing devices configured to implement the common user interface, and communication resources configured to communicate user commands to the control unit for execution.

19. A control panel for a home automation system, the control unit comprising:
processing resources for executing programmed instructions;
server processes executing on the processing resources; and
application processes executing on the processing resources.
